(19) United States
(12) Patent Application Publication
(10) Pub. No.: US 2016/0364739 A1
(43) Pub. Date: Dec. 15, 2016

(54) DRIVER MOVEMENT ANALYSIS

(71) Applicant: INRIX, Inc., Kirkland, WA (US)

(72) Inventors: Steve Dann, Torrance, CA (US); Uri Lavee, Tel Aviv (IL)

(21) Appl. No.: 14/734,419

(22) Filed: Jun. 9, 2015

(51) Int. Cl. G06Q 30/02; G08G 1/00

(52) U.S. Cl. CPC G06Q 30/0205; G08G 1/207

(57) ABSTRACT

One or more techniques and/or systems are provided for analyzing driver movement. For example, map data is evaluated to identify a point of interest such as a car dealership. A geofence zone is defined to encompass the point of interest within the map (e.g., the car dealership, a parking lot for the car dealership, etc.). Location data, such as global positioning system data, of vehicles is evaluated to determine a count of vehicles that encountered the geofence zone. A visitor count of drivers that visited the car dealership is determined based upon the count of vehicles (e.g., vehicles that remained within the geofence zone for a threshold amount of time indicative of a visit). Driver demographics, vehicle type distributions, and/or other information is determined for the point of interest and/or other points of interest (e.g., distributions of vehicle types that visit the car dealership compared to a local body shop).

### BACKGROUND

Many devices, such as smart phones, vehicle navigation units, wearable devices, etc., may comprise communication and/or navigation functionality such as cellular communication and global positioning system (GPS) technology. In an example, a user may travel with such a device while in a vehicle. For example, the user may travel with a smart phone from home to a coffee shop, and then to work. Retailers and businesses, such as the coffee shop, may desire to better understand customers, such as when and what type of customers come to the coffee shop. Unfortunately, such establishments may lack adequate techniques for identifying visitors and collecting information about the visitors.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for analyzing driver movement are provided herein. In an example, map data may be evaluated to identify a point of interest on a map, such as a business, a retailer, a restaurant, or any other location or entity that a user may visit. A geofence zone may be defined to encompass the point of interest within the map (e.g., the geofence zone may encompass the entire point of interest, a portion of the point of interest, or another location associated with the point of interest such as a nearby parking lot or parking deck). Locational data of vehicles (e.g., a sequence of locational points corresponding to a route driven by a vehicle) may be evaluated to determine a count of vehicles that encountered the geofence zone (e.g., an enter zone count, an exit zone count, a count of vehicles that encountered the geofence zone during a particular timespan, etc.). A visitor count of drivers that visited the point of interest may be determined based upon the count of vehicles (e.g., a driver may be determined as a visitor of a movie theater based upon the driver encountering and remaining within a geofence zone encompassing the movie theater for a threshold amount of time that is indicative of the driver viewing a movie). In an example, demographic information, such as age, gender, occupation, zip code, income, social network information, interests, hobbies, purchasing preferences, and/or other information may be determined for a driver that encountered the geofence zone. It may be appreciated that a driver may be prompted to provide affirmative consent for the use of information used to identify the driver (e.g., the driver may create a driver profile, provide access to a social network profile, etc.). Distributions of vehicle types, drivers, and/or other information may be determined for various points of interest. In this way, a point of interest, such as a business, may be provided with information relating to people that visit the business.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of analyzing driver movement.

FIG. 2A is a component block diagram illustrating an exemplary system for analyzing driver movement, where a geofence zone is defined.

FIG. 2B is a component block diagram illustrating an exemplary system for analyzing driver movement, where a visitor count is determined.

FIG. 2C is a component block diagram illustrating an exemplary system for analyzing driver movement, where visitor statistics information for a point of interest is determined.

FIG. 3A is a component block diagram illustrating an exemplary system for analyzing driver movement, where a first geofence zone and a second geofence zone are defined.

FIG. 3B is a component block diagram illustrating an exemplary system for analyzing driver movement, where a first visitor count and a second visitor count are determined.

FIG. 3C is a component block diagram illustrating an exemplary system for analyzing driver movement, where first visitor statistics information and second visitor statistic information are determined.

FIG. 4A is a component block diagram illustrating an exemplary system for analyzing driver movement, where a geofence zone is defined.

FIG. 4B is a component block diagram illustrating an exemplary system for analyzing driver movement, where a waypoint correlation and driver demographic information is determined.

FIG. 5 is an illustration of an exemplary computer readable medium wherein processor-executable instructions configured to embody one or more of the provisions set forth herein may be comprised.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for analyzing driver movement are provided herein. Information, such as demographic information of visitors, vehicle type information, visitor count information, etc., may be determined for an establishment (e.g., a retailer, a business, a restaurant, or any other location or entity) based upon an evaluation of locational data of vehicles to identify vehicles that encountered a geofence zone defined to encompass a point of interest such as the establishment. In this way, the establishment may learn about peak visitor times, types of vehicles used to travel to the establishment, demographics of visitors, shopping preferences, how long visitors stayed at the establishment, etc. Otherwise, establishments may lack technology to determine such information, and thus may be unable to tailor experiences for visitors.

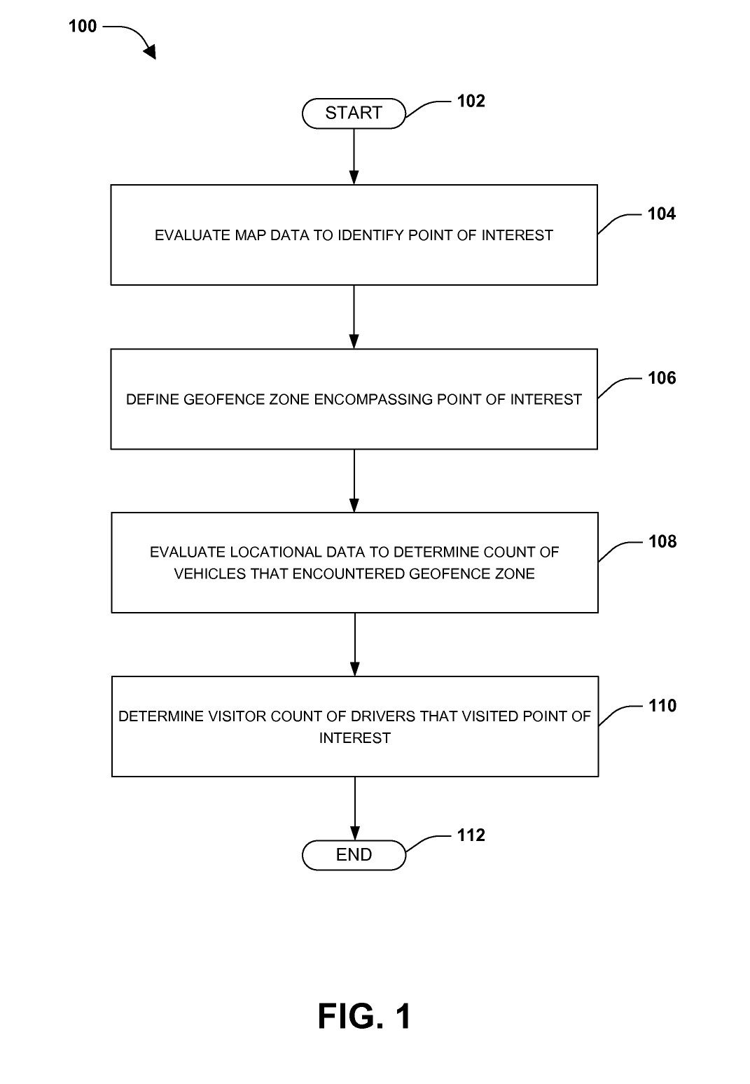

An embodiment of analyzing driver movement is illustrated by an exemplary method 100 of FIG. 1. At 102, the method 100 starts. At 104, map data may be evaluated to identify a point of interest within a map. The point of interest may correspond to a business, a retailer, a restaurant, or any other location or entity (e.g., a mechanic, a fast food restaurant, a shopping mall, a car dealership, etc.). For example, the map data may specify coordinates for a car dealership. At 106, a geofence zone may be defined to encompass the point of interest within the map. For example, the geofence zone may encompass the car dealership (e.g., defined/drawn around the point of interest as a bounding region or boarder that encompasses areas within which visitors of the car dealership may drive and/or park a vehicle), a portion of the car dealership, and/or on street parking for the car dealership.

At 106, locational data of vehicles (e.g., GPS data, transmitted by smart phones, wearable devices, vehicle navigation units, or other devices, that corresponds to locational points of a vehicle) may be evaluated to determine a count of vehicles that encounter the geofence zone. In an example, GPS coordinates of a vehicle may be compared to GPS coordinates defining the geofence zone to determine whether the vehicle encounters the geofence zone. In an example, a temporal constraint may be applied to the locational data of vehicles. For example, the car dealership may be interested in determining information about drivers that visit the car dealership between 2:00 pm and 4:00 pm on Mondays and Wednesdays, and thus the temporal constraint may filter the location data to information between 2:00 pm and 4:00 pm on Mondays and Wednesdays. In an example, the count of vehicles may correspond to an enter zone count (e.g., vehicles that entered the geofence zone between 2:00 pm and 4:00 pm) and/or an exit zone count (e.g., vehicles that exited the geofence zone between 2:00 pm and 4:00 pm).

At 110, a visitor count of drivers that visited the point of interest may be determined based upon the count of vehicles and/or other information. In an example, location data of a vehicle may be evaluated to determine whether the vehicle encountered and remained within the geofence zone for a threshold timespan indicating that a driver of the vehicle visited the point of interest (e.g., a 2 minute or greater timespan may be set for a fast food restaurant; a 30 minute or greater timespan may be set for a movie theater; etc.). In an example, the visitor count may be defined as a count of drivers that visited the point of interest during a timespan corresponding to a temporal constraint.

Various information may be identified for the point of interest based upon the visitor count of drivers and/or other data. In an example, a route of a vehicle that encountered the geofence zone may be determined. A position along the route may be identified as a home of a driver of the vehicle. Demographic information may be determined for the driver based upon the location of the home. For example, a zip code of the home may be identified. Demographic information for the zip code may be obtained, such as an average income demographic, average age demographic, gender, and/or a variety of other information. In another example, a second position along the route may be identified as an employer of the driver. Demographic information for the driver may be determined based upon the employer (e.g., a salary range, an occupation, an industry for which the driver works, etc.). In another example, location information provided by the vehicle may specify identifying information for the driver (e.g., the driver may have created a profile and provided affirmative consent for access to various information about the driver). Social network information and/or other information about the driver may be evaluated to determine demographic information about the driver.

In another example, a timespan spent by the driver of the vehicle at the point of interest may be identified based upon the locational data of vehicles (e.g., an amount of time the driver spent at the car dealership before driving the vehicle outside the geofence zone, such as an amount of time between when the vehicle entered and then exited the geofence zone). In another example, a distribution of vehicle types of vehicles that encountered the geofence zone may be determined (e.g., a distribution based upon vehicle manufacturer, model, year, color, and/or other information specified within the locational data of vehicles).

In another example where the point of interest comprises a business, a segment of drivers that visited the business may be identified (e.g., 25 year old males may correspond to 70% of visitors of a videogame retailer). A buying preference of the segment of drivers may be identified (e.g., numerous drivers may visit a particular fast food restaurant within a threshold timespan before or after visiting the videogame retailer). In an example, vehicle types of vehicles used to travel to the business may be identified (e.g., a majority of drivers may drive vehicles in the range of $10,000 to $25,000 to the videogame retailer). In an example, a peak visit time for the business may be identified based upon the visitor count of drivers (e.g., a distribution of visitors over time may be determined, which may indicate peak shopping times for the videogame retailer).

In another example, a vehicle that encountered the geofence zone may be determined. A driver of the vehicle may be identified (e.g., the vehicle or a smartphone of the driver may have provided driver identifying information). An interest in a consumer good or service may be specified for the driver based upon the driver visiting the business. For example, the driver may be identified as having an interest in videogames. Accordingly, supplemental content such as articles, websites, advertisements, recommendations, coupons, and/or other information may be identified as corresponding to the interest, and may be displayed to the driver through a user interface, a mobile alert, an email, a text message, a vehicle navigation unit, a website, etc.

In another example, a route of a vehicle that encountered the geofence zone may be determined. A location, along the route, may be identified as being visited by the vehicle. For example, a driver may stop at a local auto shop location before going to a local race track as the point of interest. A waypoint correlation between the local auto shop location and the local race track may be specified, such as a correlation that visitors of the local race track may be likely to also visit the local auto shop, and thus visitors of the local race track may be provided with supplemental content regarding the local auto shop such as advertisements.

In another example, the map data may be evaluated to identify a second point of interest within the map, such as a local auto body shop. A second geofence zone may be defined to encompass the second point of interest within the map. The locational data of vehicles may be evaluated to determine a second count of vehicles that encountered the second geofence zone. A second visitor count of drivers that visited the second point of interest may be determined (e.g., vehicles that encountered the second geofence zone for a threshold amount of time). Visitor information for the second point of interest, such as the local auto body shop, and the second point of interest, such as the car dealership, may be compared such as to determine a distribution of drivers that visited the point of interest in comparison to the second point of interest (e.g., a comparison of the types of vehicles, driver demographics, time spent at a point of interest, and/or other comparison metrics). At 112, the method 100 ends.

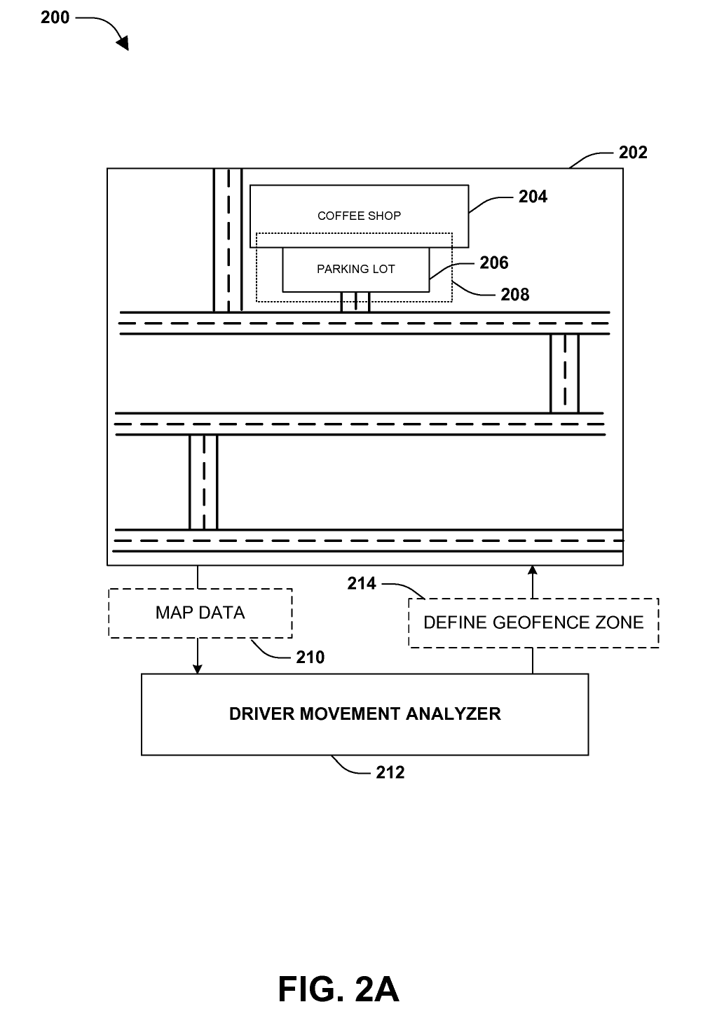

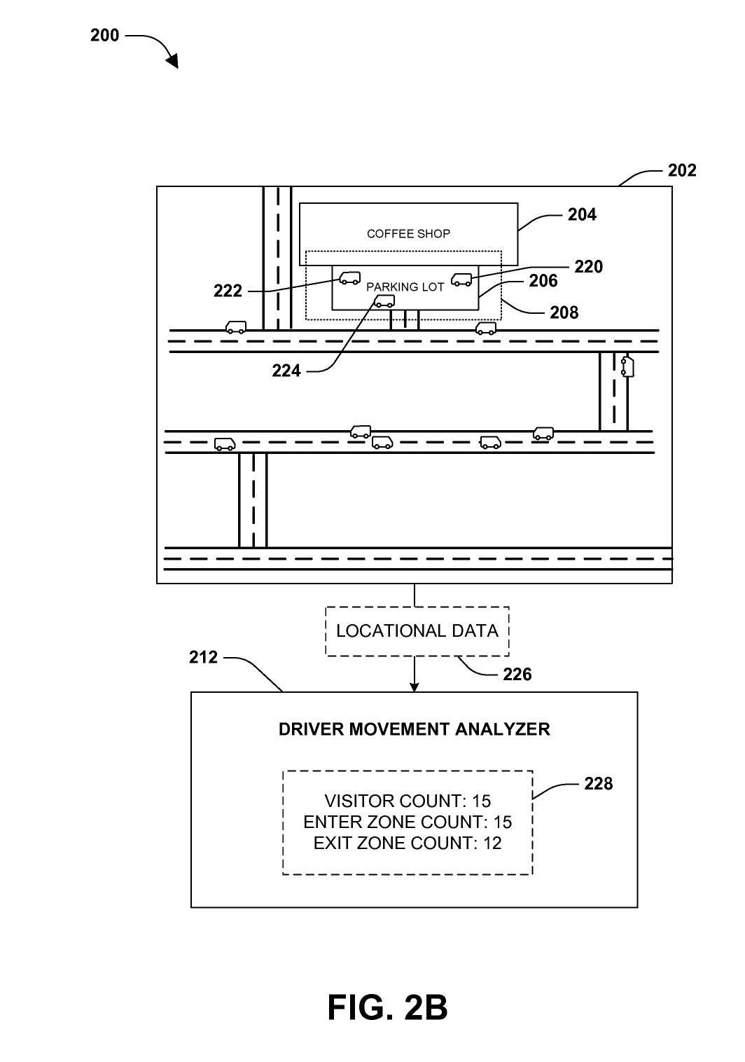

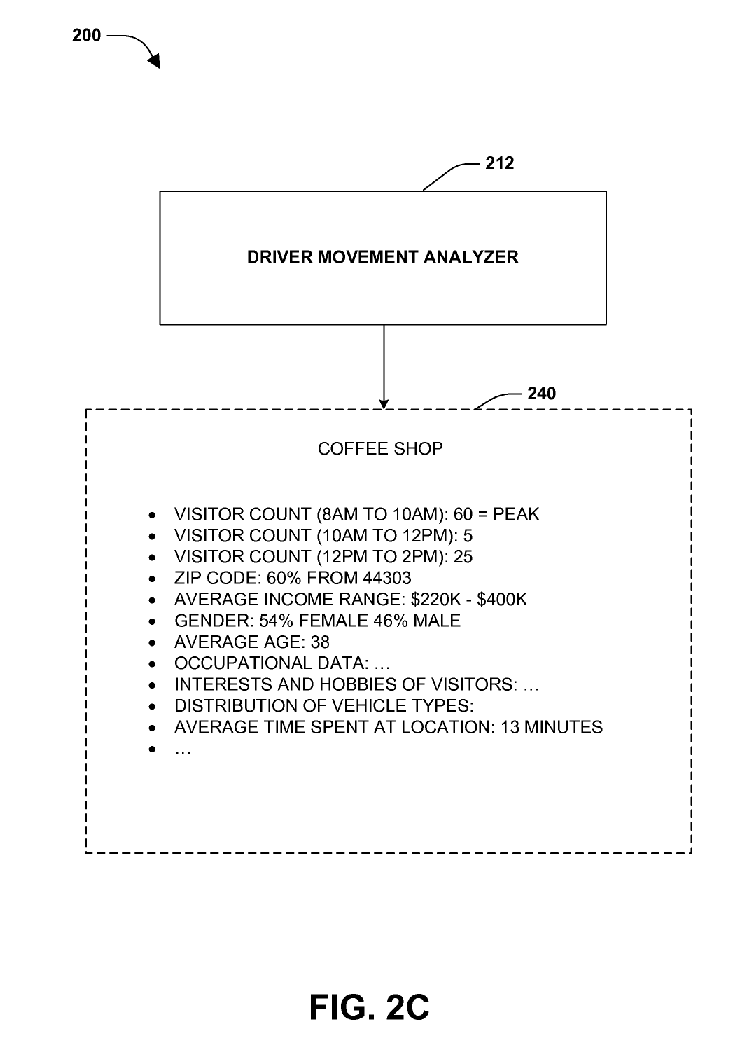

FIGS. 2A-2C illustrate examples of a system 200, comprising a driver movement analyzer 212, for analyzing driver movement. FIG. 2A illustrates the driver movement analyzer 212 evaluating map data 210 of a map 202 to identify a point of interest, such as a coffee shop 204. The driver movement analyzer 212 may define 214 a geofence zone 208 to encompass the point of interest, such as a parking lot 206 and a portion the coffee shop 204. It may be appreciated that a geofence zone 208 may encompass an entire point of interest, a portion of a point of interest, or another location associated with the point of interest such as a parking lot, street side parking, etc. (e.g., the geofence zone 208 may encompass a portion of the coffee shop 204 and the entire parking lot 206).

FIG. 2B illustrates the driver movement analyzer 212 evaluating locational data 226 of vehicles. For example, the locational data 226 may be sent from vehicle navigation units, smart phones of drivers, and/or other computing devices to the driver movement analyzer 212 (e.g., transmission of information such as cellular tower connectivity information and/or GPS location data over a wireless network to a computing device, such as a server, hosting the driver movement analyzer 212). The driver movement analyzer 212 may evaluate the locational data 226 of the vehicles to determine a count 228 of vehicles the encountered the geofence zone 208. For example, the locational data 226 may be constrained by a temporal constraint specifying a timespan between 7:00 am and 8:00 am on a Tuesday, which may be used to filter the locational data 226. In an example, the locational data 226 may indicate that at 7:59 am, a first vehicle 220, a second vehicle 222, and a third vehicle 224 were currently within the geofence zone 208. The locational data 226 may indicate that 15 vehicles had entered the geofence zone 208 between 7:00 am and 8:00 am and that 13 vehicles had exited the geofence zone 208 by 8:00 am. The driver movement analyzer 212 may determine a visitor count of 15 drivers that visited the coffee shop 204 based upon the count 228 of vehicles.

FIG. 2C illustrates the driver movement analyzer 212 determining visitor statistics information 240 for the point of interest, such as the coffee shop 204. For example, the visitor statistics information 240 may specify a visitor count from 8:00 am to 10:00 am as a peak visitor time, a visitor count from 10:00 am to 12:00 pm; and a visitor count from 12:00 pm to 2:00 pm. The visitor statistics information 240 may specify zip code information of visitors that visited the coffee shop 204, such as an indication that 60% of visitors live in a 44303 zip code (e.g., routes traveled by visitors may be evaluated to determine home locations of such visitors, such as where a home location may be identified based upon a user leaving the home location during weekday mornings to go to work). The visitor statistics information 240 may specify that 54% of visitors were female and 46% of visitors were male (e.g., the locational data 226 may provide driver identification information, such as a user name, account, or profile). The visitor statistics information 240 may specify that the average age of visitors were 38 years old. The visitor statistics information 240 may specify occupational data, interests and hobbies of visitors, and/or other information derived from social network data, profiles, and/or driving patterns (e.g., the driver identification may be used to identify a social network profile through which the user has specified interests and hobbies). The visitor statistics information 240 may specify a distribution of vehicle types of vehicles that encountered the geofence zone 208 (e.g., the location data 226 may provide vehicle identification information used to determine vehicle types of vehicles). The visitor statistics information 240 may specify an average time spent at the coffee shop 204 (e.g., a timespan between an enter zone event and an exit zone event of a vehicle entering and leaving the geofence zone 208).

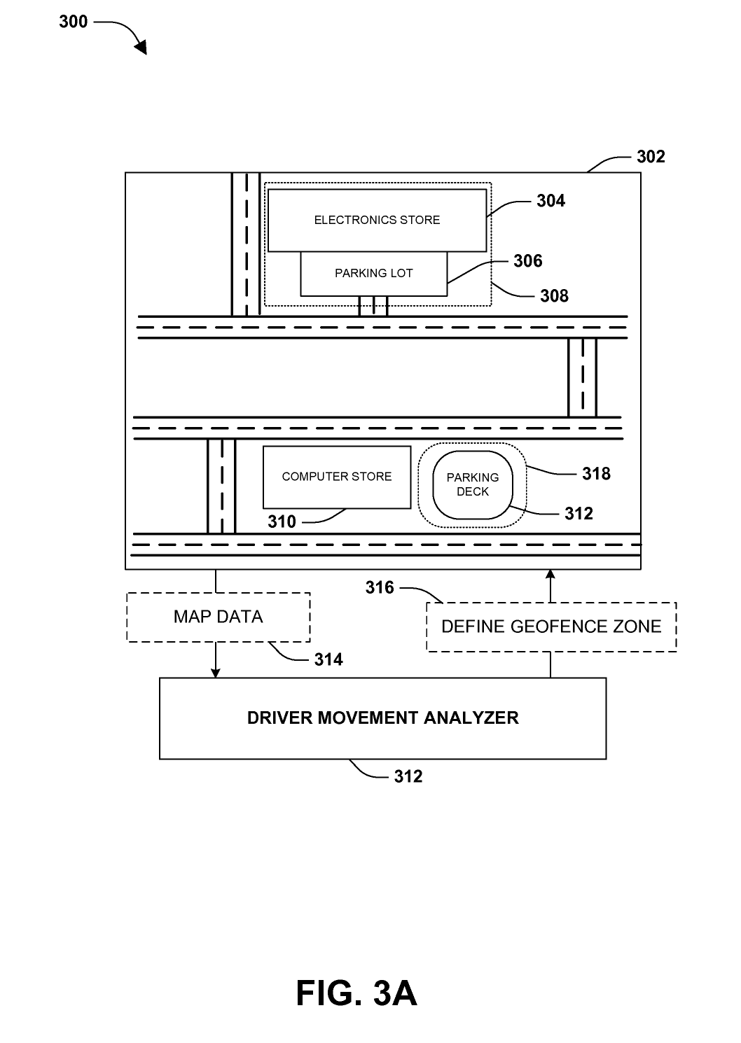

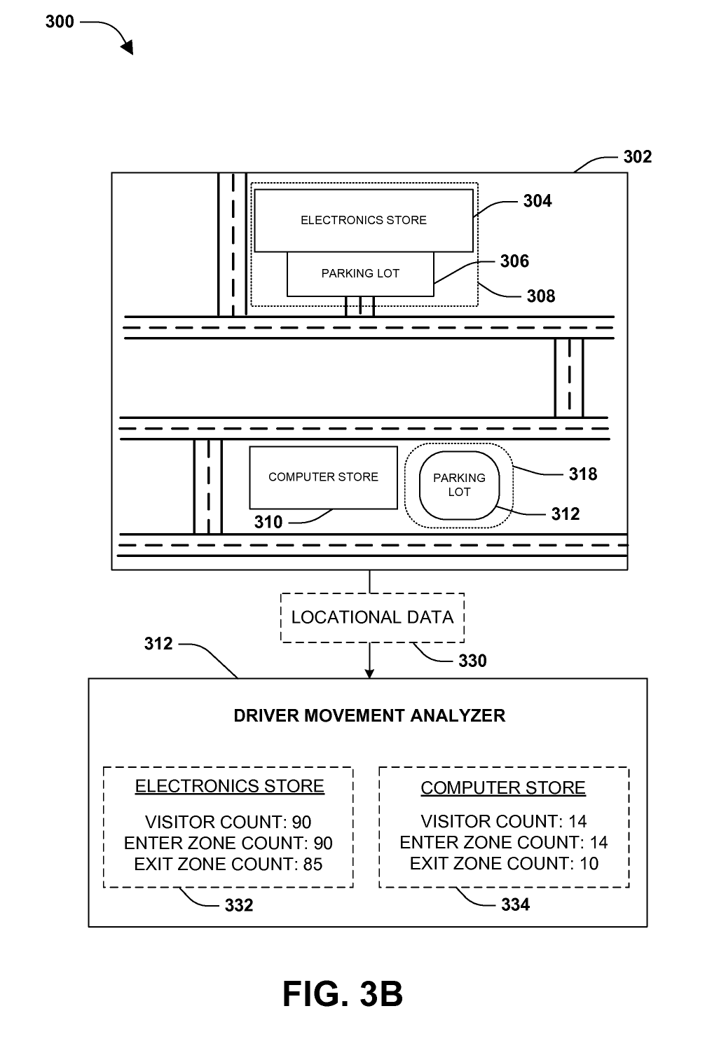

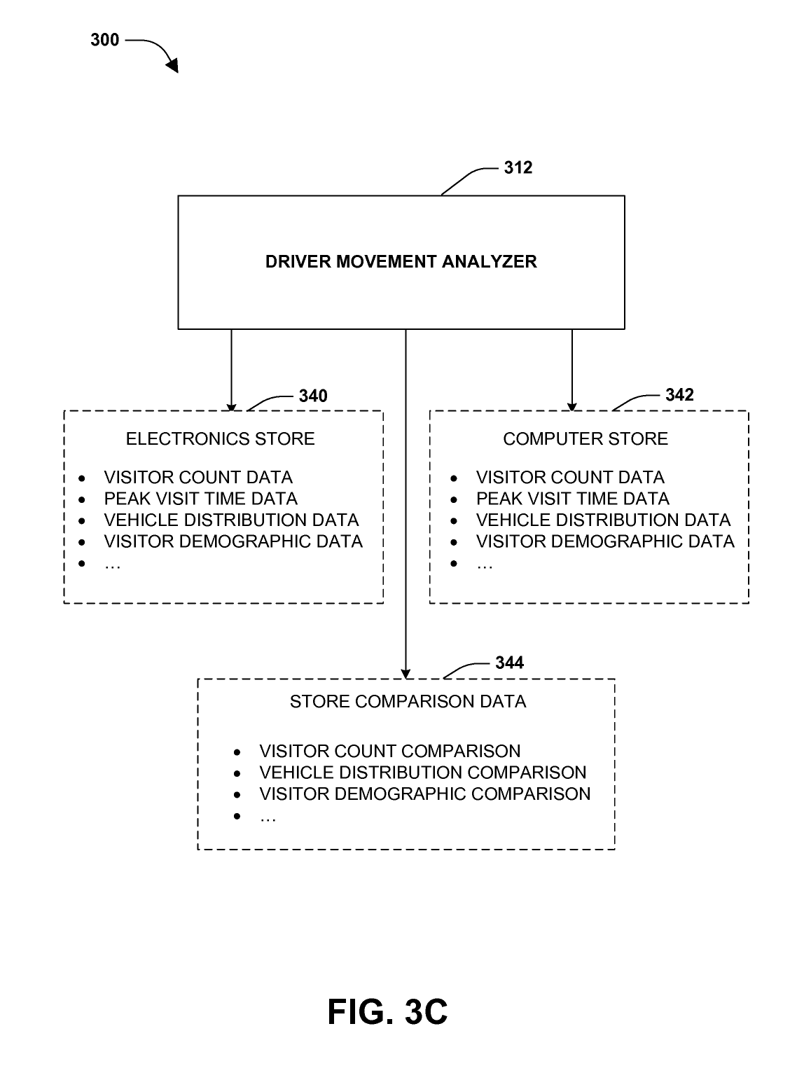

FIGS. 3A-3C illustrate examples of a system 300, comprising a driver movement analyzer 312, for analyzing driver movement. FIG. 3A illustrates the driver movement analyzer 312 evaluating map data 314 of a map 302 to identify a first point of interest such as an electronics store 304 and a second point of interest such as a computer store 310. The driver movement analyzer 312 may define 316 a first geofence zone 308 for the first point of interest, such as to encompass the electronics store 304 and a parking lot 306 for the electronics store 304, and a second geofence zone 318 for the second point of interest, such as to encompass a parking deck 312 for the computer store 310. It may be appreciated that a geofence zone may encompass an entire point of interest, a portion of a point of interest, or another location associated with the point of interest such as a parking lot, street side parking, etc.

FIG. 3B illustrates the driver movement analyzer 312 evaluating locational data 330 of vehicles. For example, the locational data 330 may be sent from vehicle navigation units, smart phones of drivers, and/or other computing devices to the driver movement analyzer 312 (e.g., transmission of information such as cellular tower connectivity information and/or GPS location data over a wireless network to a computing device, such as a server, hosting the driver movement analyzer 312). The driver movement analyzer 312 may evaluate the locational data 330 of the vehicles to determine a first count 332 of vehicles the encountered the first geofence zone 308 associated with the electronics store 304 and a second count 334 of vehicles that encountered the second geofence zone 318 associated with the computer store 310.

FIG. 3C illustrates the driver movement analyzer 312 determining first visitor statistics information 340 for the first point of interest such as the electronics store 304 and second visitor statistics information 342 for the second point of interest such as the computer store 310. For example, the first visitor statistics information 340 may comprise visitor count data, peak visit time data, vehicle type distribution data, visitor demographic data, and/or other information associated with drivers that visited the electronics store 304. The second visitor statistics information 342 may comprise visitor count data, peak visit time data, vehicle type distribution data, visitor demographic data, and/or other information associated with drivers that visited the computer store 310. The driver movement analyzer 312 may evaluate the first visitor statistics information 340 against the second visitor statistics information 342 to determine store comparison data 344 that compares vehicle count, vehicle type distribution, and visitor demographic information between the electronics store 304 and the computer store 310.

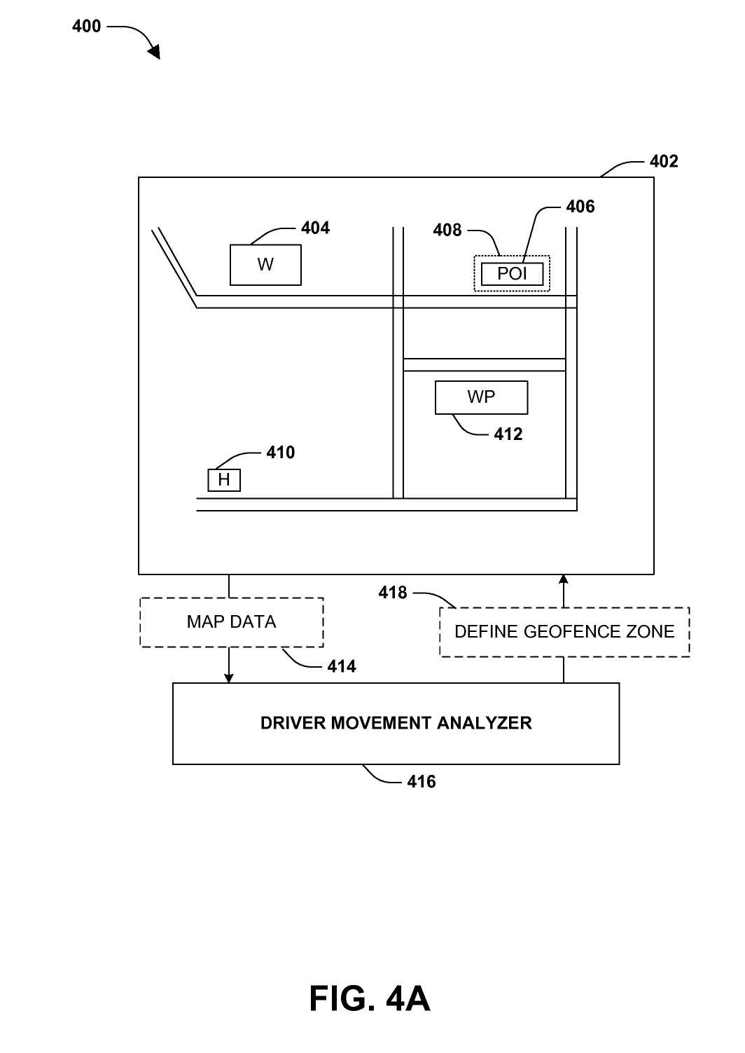

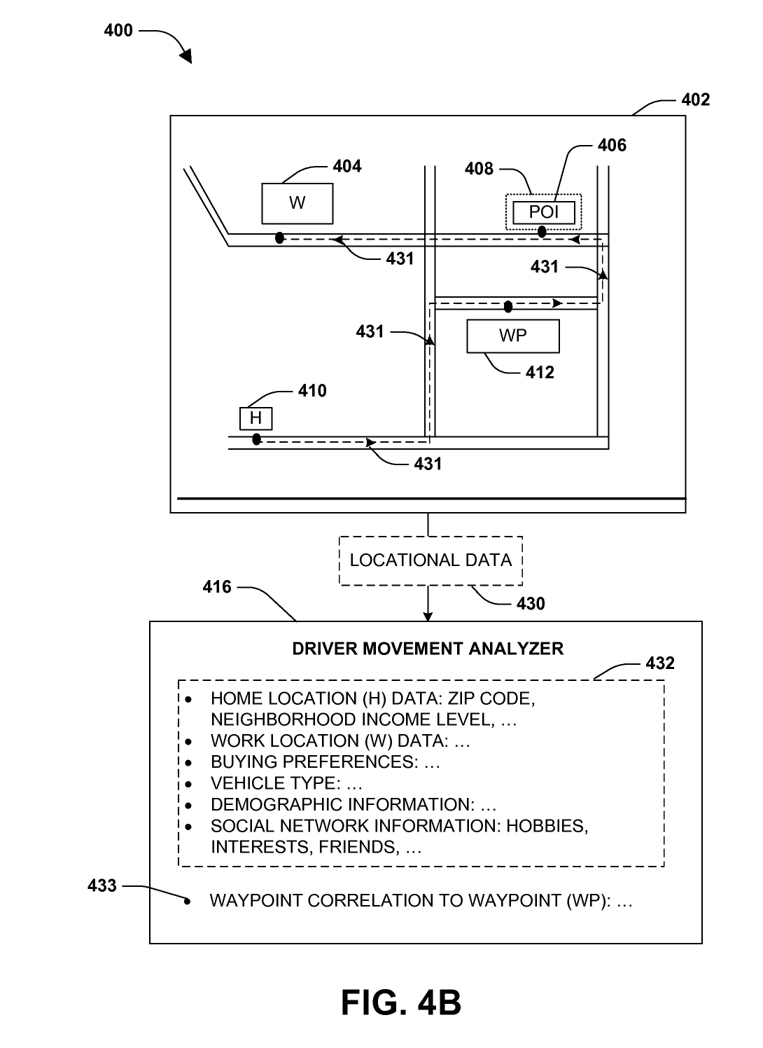

FIGS. 4A-4B illustrate examples of a system 400, comprising a driver movement analyzer 416, for analyzing driver movement. FIG. 4A illustrates the driver movement analyzer 416 evaluating map data 414 of a map 402 depicting a location comprising a driver's house 410, a driver's work 404, a waypoint newspaper stand 412, and a point of interest coffee shop 406. The driver movement analyzer 416 may evaluate the map data 414 to identify the point of interest coffee shop 406 within the map 402. The driver movement analyzer 416 may define 418 a geofence zone 408 encompassing the point of interest coffee shop 406.

FIG. 4B illustrates the driver movement analyzer 416 evaluating location data 430 comprising locational points traveled by a driver of a vehicle. The driver movement analyzer 416 may evaluate the locational data 430 to determine that the vehicle encountered the geofence zone 408, and thus the driver may be determined as having visited the point of interest coffee shop 406 (e.g., the vehicle may have remained within the geofence zone 408 for a threshold amount of time that is indicative of the driver visiting the coffee shop 406 as opposed to merely short cutting through a parking lot of the coffee shop 406). The driver movement analyzer 416 may evaluate the locational data 430 to identify a route 431 traveled by the driver. The driver movement analyzer 416 may evaluate the route 431 to determine that the driver started the route 431 at the driver's house 410, drove to the waypoint newspaper stand 412 for a newspaper, drove to the point of interest coffee shop 406 for coffee, and then drove to the driver's work 404. The driver movement analyzer 416 may specify a waypoint correlation 433 between the waypoint newspaper stand 412 and the point of interest coffee shop 406. The waypoint correlation 433 may indicate that users that are interested in the waypoint newspaper stand 412 may also be interested in the point of interest coffee shop 406 and vice versa. The driver movement analyzer 416 may determine driver demographic information 432 for the driver, such as the location of the driver's home 410 (e.g., a zip code), a neighborhood income level of the zip code, information about the driver's work 404, buying preferences of the driver such as newspapers and coffee, a vehicle type driven by the driver, demographic information such as age and gender, social network information such as hobbies, interests (e.g., a social network post “I cannot wait for the new soccer magazine” may indicate that the driver has an interest in soccer and reading magazines), friends, and/or a variety of other information for which the driver may have provided content to access or determine.

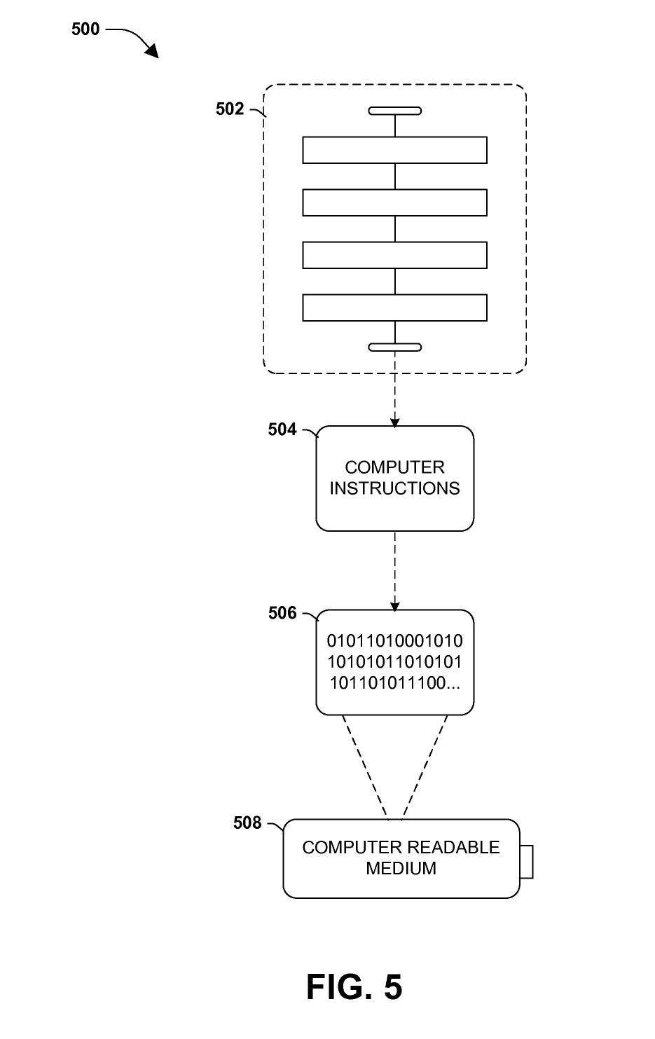

Still another embodiment involves a computer-readable medium comprising processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the set of computer instructions 504 are configured to perform a method 502, such as at least some of the exemplary method 100 of FIG. 1, for example. In some embodiments, the set of computer instructions 504 are configured to implement a system, such as at least some of the exemplary system 200 of FIGS. 2A-2C, at least some of the exemplary system 300 of FIGS. 3A-3C, and/or at least some of the exemplary system 400 of FIGS. 4A-4B, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

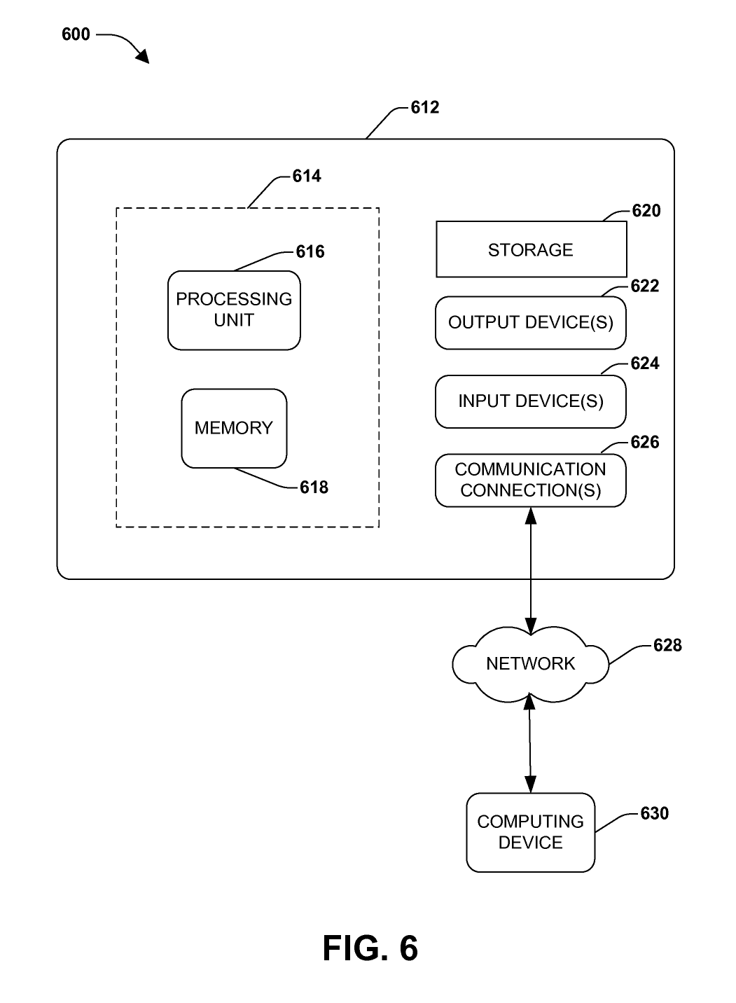

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via a network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for analyzing driver movement, comprising:
evaluating map data to identify a point of interest within a map;
defining a geofence zone encompassing the point of interest within the map;
evaluating locational data of vehicles to determine a count of vehicles that encountered the geofence zone; and
determining a visitor count of drivers that visited the point of interest based upon the count of vehicles.

2. The method of claim 1, comprising:
applying a temporal constraint to the locational data of vehicles; and
defining the visitor count as a count of drivers that visited the point of interest during a timespan corresponding to the temporal constraint.

3. The method of claim 1, comprising:
determining a route of a vehicle that encountered the geofence zone;
identifying a position along the route as a home of a driver of the vehicle; and
determining a demographic of the driver based upon a location of the home.

4. The method of claim 3, the determining a demographic comprising:
identifying a zip code of the home; and
evaluating demographic information of the zip code to determine an income demographic for the driver.

5. The method of claim 1, comprising:
determining a demographic of a driver of a vehicle that encountered the geofence zone, the demographic comprising at least one of a gender, age, occupation, or social network information of the driver.

6. The method of claim 1, comprising:
determining a route of a vehicle that encountered the geofence zone;
identifying a position along the route corresponding to an employer of a driver of the vehicle; and
determining a demographic of the driver based upon the employer.

7. The method of claim 1, the point of interest corresponding to a business, a retailer, or a restaurant.

8. The method of claim 1, comprising:
evaluating the map data to identify a second point of interest within the map;
defining a second geofence zone as encompassing the second point of interest within the map;
evaluating the locational data of vehicles to determine a second count of vehicles that encountered the second geofence zone; and
determining a second visitor count of drivers that visited the second point of interest.

9. The method of claim 8, comprising:
determining a distribution of drivers that visited the point of interest in comparison to the second point of interest.

10. The method of claim 1, comprising:
determining that a vehicle encountered the geofence zone; and
identifying a timespan spent by a driver of the vehicle at the point of interest.

11. The method of claim 1, the determining a visitor count of drivers comprising:
determining at least one of an enter zone count or an exit zone count.

12. The method of claim 1, comprising:
determining that a vehicle encountered the geofence zone;
identifying a driver of the vehicle; and
specifying that the driver has an interest in a consumer good or service provided by a business located at the point of interest.

13. The method of claim 12, comprising:
identifying an advertisement as corresponding to the interest; and
displaying the advertisement through at least one of a user interface, a mobile alert, an email, a vehicle navigation unit, or a website to the driver.

14. The method of claim 1, the point of interest comprising a business, and the method comprising:
identifying at least one of a segment of drivers that visit the business, a buying preference of the segment of drivers, a vehicle type of vehicles used to travel to the business, or a peak visit time for the business based upon the visitor count of drivers.

15. The method of claim 1, comprising:
determining a distribution of vehicle types of vehicles that encountered the geofence zone.

16. The method of claim 1, comprising:
determining a route of a vehicle that encountered the geofence zone;
identifying a location, along the route, visited by the vehicle; and
specifying a waypoint correlation between the location and the point of interest.

17. A system for analyzing driver movement, comprising:
a driver movement analyzer configured to:
evaluate map data to identify a point of interest within a map;
define a geofence zone encompassing the point of interest within the map;
evaluate locational data of vehicles to determine a count of vehicles that encountered the geofence zone; and
determine a visitor count of drivers that visited the point of interest based upon the count of vehicles.

18. The system of claim 17, the driver movement analyzer configured to:
determine a demographic of a driver of a vehicle that encountered the geofence zone, the demographic comprising at least one of a zip code, an income, a gender, an age, an occupation, or social network information of the driver.

19. The system of claim 17, the driver movement analyzer configured to:
evaluate the map data to identify a second point of interest within the map;
define a second geofence zone encompassing the second point of interest within the map;
evaluate the locational data of vehicles to determine a second count of vehicles that encountered the second geofence zone;
determine a second visitor count of drivers that visited the second point of interest; and
determine a distribution of drivers that visited the point of interest in comparison to the second point of interest.

20. A computer readable medium comprising instructions which when executed perform a method for analyzing driver movement, comprising:
evaluating map data to identify a point of interest within a map;
defining a geofence zone encompassing the point of interest;
evaluating locational data of vehicles to determine a count of vehicles that encountered the geofence zone;
determining a visitor count of drivers that visited the point of interest based upon the count of vehicles; and
determining a demographic of a driver of a vehicle that encountered the geofence zone, the demographic comprising at least one of a zip code, an income, a gender, an age, an occupation, or social network information of the driver.
